(19) United States
(12) Patent Application Publication
(10) Pub. No.: US 2018/0157863 A1
(43) Pub. Date: Jun. 7, 2018

(54) METHOD AND APPARATUS FOR STORING PRIVACY INFORMATION BASED ON APPLICATION

(71) Applicant: BEIJING KINGSOFT INTERNET SECURITY SOFTWARE CO., LTD., BEIJING (CN)

(72) Inventors: Zhifei TAO, BEIJING (CN); Zhifeng CHEN, BEIJING (CN); Guifeng LIU, BEIJING (CN)

(21) Appl. No.: 15/578,130

(22) PCT Filed: Aug. 18, 2016
(86) PCT No.: PCT/CN2016/095896

§ 371 Date: Nov. 29, 2017

(30) Foreign Application Priority Data
Jun. 29, 2015 (CN) 201510369784.X

(51) Int. Cl. G06F 21/62; G06F 21/50; G06F 17/30

(52) U.S. Cl. CPC G06F 21/6245; H04L 9/0625; G06F 17/301; G06F 21/50

(57) ABSTRACT

The present disclosure provides a method and an apparatus for storing privacy information based on an application. The method includes: after monitoring that the application has been started, receiving a file read/write request from the started application, and redirecting the file read/write request to a use trace file mapped by an identifier of the application and preset in a memory; performing a read/write operation corresponding to the file read/write request on the use trace file; and after monitoring that the application exits, erasing the use trace file mapped by the application in the memory according to a preset erasing strategy.

### CROSS-REFERENCE TO RELATED APPLICATION

This application is based on and claims priority to and benefits of Chinese Patent Application Serial No. 201510369784.X, filed with the State Intellectual Property Office of P. R. China on Jun. 29, 2015, the entire contents of which are incorporated herein by reference.

### FIELD

The present disclosure relates to a field of network communication security technology, and more particularly relates to a method and an apparatus for storing privacy information based on an application.

### BACKGROUND

When a user uses an application installed in a client such as a mobile phone, a personal digital assistance, a desk computer, a laptop and a smart device, massive use traces may be generated. These use traces may include privacy information of the user. Especially, for some applications via which the user accesses the Internet, for example, WeChat, QQ, email, online payment and the like, privacy information such as a user name, a password and an email address may be used. When the user uses the above applications, in order to simplify an operation process of the user, a network server may store the information generated when the user access the network into a hard disk or a flash memory of the client by means of writing into a registry, a local database, an initialization file (INI for short) and other unencrypted files, so as to generate a small text file (i.e., the cookie file) corresponding to the network server, such that when the user accesses the network server again, the user may not have to re-input the related privacy information. A storing location of the cookie file in the hard disk or the flash memory is closely related to an operating system and the browser used by the client. For example, in a computer using Windows 9X operating system, the storing location of the cookie file is C:Windows Cookies, and in a computer using Windows NT/2000/XP operating system, the storing location of the cookie file is C:Documents and Settings.

With a frequent use of various applications, the browser records and writes the user's use traces into the hard disk or the flash disk continuously, such that the use trace file (such as the cookie file) stored in the hard disk or the flash memory becomes larger and larger, and the privacy information included becomes more and more. Therefore, some lawbreakers may acquire the user's use traces from the use trace file such as the registry, the local database and the initialization file stored in the hard disk or the flash memory by hacking into the user's client. Since the use traces are usually recorded in the use trace file with plain text, the lawbreakers may acquire the user's privacy information easily by analyzing the acquired use traces, leading to a leakage of user's privacy information and further leading to a mental damage and a property loss for the user, for example, user's ID is stolen, or the user's bank card is used under someone else's name.

In order to reduce the risk of privacy information leakage caused by an unlawful hacking into the client, some applications may periodically erase the use traces, for example, by setting clearing buffer in the application to erase a part of the use traces (data), a storing period of which exceeds a preset time threshold. In this way, it may reduce an amount of use traces acquired by the lawbreaker, thus reducing the risk of leakage of privacy information of the user. However, in this method, only the use traces lasting beyond a preset time threshold are erased, most of the use traces are still stored in the use trace file, and the use trace file still includes massive privacy information, thus resulting in a low security of the privacy information storage. Further, not all of the applications have been provided with an extended application function such as clearing the buffer, the security of the privacy information is even lower for those applications which have not provided with the extended application function such as clearing the buffer. In addition, even though the user uninstalls the application, the use traces stored in the hard disk or the flash memory cannot be cleared along with the uninstalling of the application. Thus, in the client in the related art, there is a big risk of leakage of privacy information, and the security of the privacy information of the user is low.

### SUMMARY

Embodiments of the present disclosure aim to provide a method and an apparatus for storing privacy information based on an application, so as to improve the security of the privacy information for the user.

In order to achieve the above objectives, embodiments of a first aspect of the present disclosure provide a method for storing privacy information based on an application. The method includes: after monitoring that the application has been started, receiving a file read/write request from the started application, and redirecting the file read/write request to a use trace file mapped by an identifier of the application and preset in a memory; performing a read/write operation corresponding to the file read/write request on the use trace file; and after monitoring that the application exits, erasing the use trace file mapped by the application in the memory according to a preset erasing strategy.

With the method for storing privacy information based on an application provided by embodiments of the present disclosure, by redirecting the user's disk read/write operation to the memory from the hard disk or the flash memory, the traces generated when the user uses the application may be only stored in the memory when the application is running, and when the application exists, the use traces are erased automatically by the memory, such that disk-recorded use traces may be not generated after the user uses the application without affecting the user's using the application normally. Therefore, use traces generated when the user uses the application may be reduced greatly, the privacy information of the user may be protected effectively and the security of the privacy information may be improved.

Embodiments of a second aspect of the present disclosure provide an apparatus for storing privacy information based on an application. The apparatus includes: a filtering driver module, a privacy-mode service module and a privacy-mode user interface module. The filtering driver module is configured to send a query request to the privacy-mode user interface module after monitoring that the application has been started; if a returned query response indicates that a privacy mode is set for the started application, after receiving a file read/write request from the started application, redirect the file read/write request to a use trace file mapped by an identifier of the application and preset in a memory and send a starting notification to the privacy-mode service module; and after monitoring that the application exits, send an exiting notification to the privacy-mode service module and the privacy-mode user interface module respectively. The privacy-mode service module is configured to receive the starting notification, to perform a read/write operation corresponding to the file read/write request on the use trace file, to receive the exiting notification, and to erase the use trace file mapped by the application in the memory according to a preset erasing strategy and to remove a process corresponding to the exited application. The privacy-mode user interface module is configured to: set the privacy mode for the application; after receiving the query request sent by the filtering driver module, if the application is set with the privacy mode, start the privacy-mode service module and return the query response indicating that the started application is set with the privacy mode to the filtering driver module; and receive the exiting notification from the filtering driver module, and close the privacy-mode service module after monitoring that the privacy-mode service module has erased the use trace file.

With the apparatus for storing privacy information based on an application, the privacy mode user interface module may set the privacy mode for the application, the filtering driver module may redirect the disk read/write operation of the application set with the privacy mode to the memory, the privacy mode service module may perform the read/write operation in the redirected use trace file, and erase the use trace file mapped by the application in the memory after the application exits, such that the use traces generated when the user uses the application may be only stored in the memory when the application is running, and when the application exists, the use traces are erased automatically by the memory, such that the use traces may be not left after the user uses the application without affecting the user using the application normally. Therefore, use traces generated when the user uses the application may be reduced greatly, such that the privacy information may be protected effectively and the security of the privacy information may be improved.

Embodiments of a third aspect of the present disclosure provide a client. The client includes a housing, a processor, a memory, a circuit board and a power supply circuit. The circuit board is arranged inside a space enclosed by the housing, the processor and the memory are disposed on the circuit board enclosed; the power supply circuit is configured to supply power to respective circuits or components of the client; the memory is configured to store executable program codes; and the processor is configured to run a program corresponding to the executable program codes by reading the executable program codes stored in the memory, so as to perform the method for storing privacy information based on an application according to embodiments of the first aspect of the present disclosure.

Embodiments of a fourth aspect of the present disclosure provide a computer readable storage medium having instructions stored thereon that, when executed, performs the method for storing privacy information based on an application according to embodiments of the first aspect of the present disclosure.

Embodiments of a fifth aspect of the present disclosure provide a computer program, when running on a processor of a client, performing the method for storing privacy information based on an application according to embodiments of the first aspect of the present disclosure.

Additional aspects and advantages of embodiments of present disclosure will be given in part in the following descriptions, become apparent in part from the following descriptions, or be learned from the practice of the embodiments of the present disclosure.

### BRIEF DESCRIPTION OF THE DRAWINGS

In order to make technique solutions according to embodiments of the present disclosure more apparent, drawings needed to be used in descriptions of the embodiments will be illustrated in the following. Obviously, the drawings to be illustrated in the following only represent some embodiments of the present disclosure, and other drawings can be obtained according these drawings by those having ordinary skills in the related art without making creative labors.

FIG. 1 is a flow chart of a method for storing privacy information based on an application according to an embodiment of the present disclosure;

FIG. 2 is a block diagram of an apparatus for storing privacy information based on an application according to an embodiment of the present disclosure; and

FIG. 3 is a block diagram of a client according to an embodiment of the present disclosure.

### DETAILED DESCRIPTION

Reference will be made in detail to embodiments of the present disclosure.

It should be noted that, embodiments described are a part of embodiments of the present invention, but not all embodiments. All other embodiments obtained by those skilled in the art based on the embodiments in the present invention without creative labor shall fall in the protection scope of the present invention.

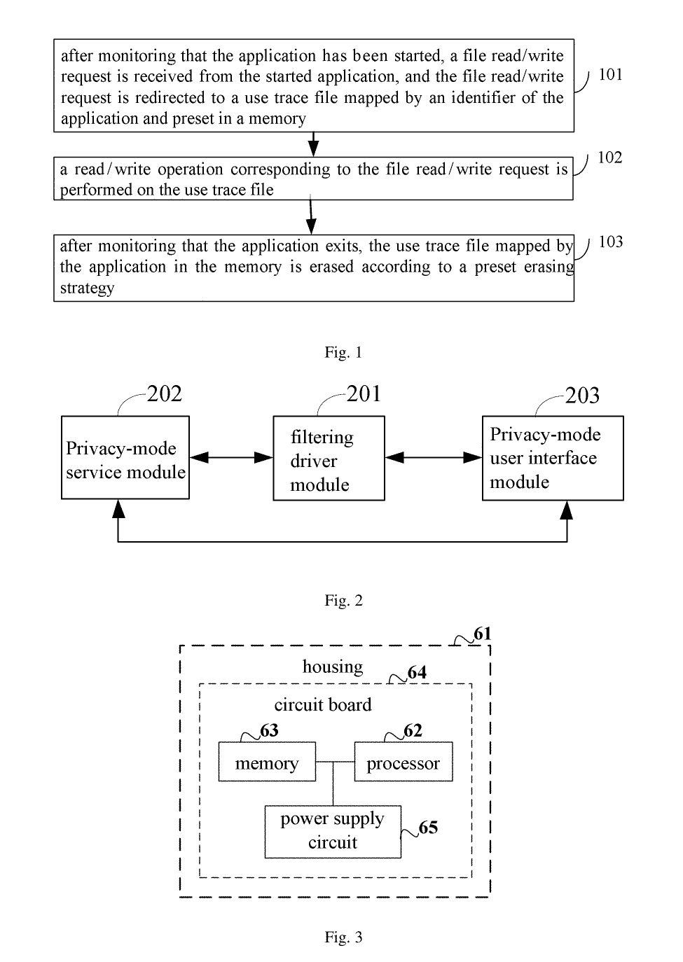

FIG. 1 is a flow chart of a method for storing privacy information based on an application according to an embodiment of the present disclosure. As illustrated in FIG. 1, the method includes the followings.

At block 101, after monitoring that the application has been started, a file read/write request from the started application is received, and the file read/write request is redirected to a use trace file mapped by an identifier of the application and preset in a memory.

At this block, since in the related art, the use trace file stored in the hard disk or the flash memory cannot be cleared away along with the uninstalling of the application, lawbreakers may access the use trace file stored in the hard disk or the flash memory by hacking into the client, leading to leakage of the privacy information of the user. In embodiments of the present disclosure, considering that the memory in the client, as a storage medium for storing operational data of a CPU of the client and exchanging data between the CPU and an external memory, has characteristics of temporality and volatile storage, the use traces generated when the user uses the application is stored in the memory. In this way, when the user is using the application, the use traces generated are stored in the memory, and when the application exits or is uninstalled or when the client is restarted, the use traces stored in the memory temporarily can be erased accordingly, such that a permanent disk record stored in the hard disk or the flash memory may not be generated after the user uses the application normally. Therefore, the privacy information of the user is protected, reducing the risk of leakage of the privacy information and improving the security of the privacy information.

As an alternative embodiment, after monitoring that the application has been started and before a file read/write request from the started application is received, the method further includes followings.

At block A11, a process list corresponding to currently running applications is acquired.

At this block, during a process of starting the application, the operating system allocates one process for subsequent running of the application to the application. Each process corresponds to one running application. Therefore, the user may acquire the running applications and their corresponding running state information by checking the process list in the client.

At block A12, process states in the process list are checked, and the process state of the started application is updated from a non-privacy mode to a privacy mode. Then, the file read/write request from the application is received.

At this block, the process list includes the running state information (i.e., process states) of applications corresponding to respective processes, for example, a name of an application, an identifier of an application, a CPU usage rate and a memory usage rate. In embodiments of the present disclosure, the running state information of the application further includes privacy mode identifying information (i.e., the privacy mode or the non-privacy mode), so as to indicate whether a privacy processing according to embodiments of the present disclosure needs to be performed on the application to improve the security of the privacy information.

In embodiments of the present disclosure, according to a practical requirement, the user may select the process to be set with the privacy mode from the processes of which the process states are non-privacy mode, and set the privacy mode for these selected processes. In embodiments of the present disclosure, if the process state is set as the privacy mode, it means that the use traces of the application need to be stored in the memory in subsequent use.

Of course, in actual use, the user may update the process state which has been set as the privacy mode in the process list to the non-privacy mode, which means that the use traces of the application are stored in the hard disk or the flash memory according to the current processing in subsequent use.

As another alternative embodiment, after monitoring that the application has been started and before the file read/write request from the started application is received, the method further includes: querying a preset privacy mode list, determining whether the started application exists in the preset privacy mode list, if yes, receiving the file read/write request from the started application, and if no, promoting a user whether to set a privacy mode for the application, and performing a corresponding operation according to the user's setting.

At this block, the user may perform the privacy mode setting for the application installed in the client according to a practical requirement, and set the application to be performed with the privacy mode setting in the privacy mode list in advance, which means that the use traces of the application in the privacy mode list need to be stored in the memory in subsequent use.

At this block, as an alternative embodiment, performing a corresponding operation according to the user's setting includes: if the user selects to set the privacy mode for the application according to the promote, setting the privacy mode for the application automatically, and receiving the file read/write request from the started application; and if the user gives up to set the privacy mode for the application according to the promote, performing a current process.

At this block, if the user sets the privacy mode for the application, the client lists the application in the privacy mode list. Thus, in subsequent use, the use traces of the application may be stored in the memory.

As yet another alternative embodiment, after monitoring that the application is started and before the file read/write request from the started application is received, the method further includes: determining whether the identifier of the application carries privacy mode information, if the identifier of the application carries the privacy mode information, receiving the file read/write request from the started application, and if the identifier of the application does not carry the privacy mode information, promoting a user whether to set the privacy mode for the application, and performing a corresponding operation according to the user's setting.

At this block, each application in the client corresponds to one identifier. In this embodiment, the identifier of the application may carry the privacy mode information, which means that the use traces of the application need to be stored in the memory in subsequent use.

In actual use, the privacy mode information may be carried by extending a privacy mode identifier bit or by using an idle bit in the identifier of the application. For example, the identifier of the application is extended by one bit based on original 8 bits. If the extended bit is 1, it means that the identifier of the application carries the privacy mode information, and if the extended bit is 0, it means that the identifier of the application does not carry the privacy mode information.

In embodiments of the present disclosure, as an alternative embodiment, redirecting the file read/write request to a use trace file mapped by the identifier of the application and preset in the memory may include: querying whether the use trace file mapped by the identifier of the application exists in the memory, if yes, directing the file read/write request to the use trace file, and if no, creating a new use trace file, establishing a mapping relation between the new use trace file and the identifier of the application, and directing the file read/write request to the new use trace file.

At this block, after the application is started, read/write operation of the use traces including direct interaction information between the user and the application and the interaction information between the user and the network server via the application (i.e., the read/write operation of the application) is performed based on the use trace file mapped by the application and set in the memory. In other words, information needed to perform the application may be read from the use trace file mapped by the application, and the information input by the user or the information returned to application from the network server may be written into the use trace file in the memory, such that the use traces generated when the user uses the application may be stored in the use trace file in the memory, and in a process when the application is running, by reading the use trace file, it may reduce the number of times of inputting information by the user repeatedly, thereby simplifying the user's operation process and improving user experience.

In embodiments of the present disclosure, for each (started) application, one use trace file may be stored in the memory. Preferably, use trace files are distinguished according to identifiers of applications.

In embodiments of the present disclosure, after the use trace file is created, the method may further include: invoking a cache space allocation function, and applying for a cache space in the memory for the created use trace file.

At this block, for example, for the cookie information, a function of AlloCookieMem ( ) may be invoked to apply for the cache space for the use trace file corresponding to the cookie information.

It should be noted that, in a stage of starting (initiating) the application, the file disk read/write operation information needed to start the application is still acquired from a registry, a local database, an initialization file and the like stored in the hard disk or the flash memory when the application is installed, and the file disk read/write operation corresponding to the application may be redirected until starting the application is completed and the application is set with the privacy mode, such that the read/write operation of the application may be redirected to the memory rather than the hard disk or the flash memory. Therefore, the read/write performance of the disk may be improved in some scenes.

As an alternative embodiment, the method may further include: setting an access key for the use trace file mapped by the identifier of the application or the new use trace file using a preset encryption algorithm.

At this block, the encryption algorithm may include: data encryption method (DES), triple DES (3DES), international data encryption algorithm (IDEA), digital signature algorithm (DSA), advanced encryption standard (AES), international data encryption algorithm (IDEA), the public-key cryptography standards (PKCS), RC2, RC4 and new elliptic curve encryption algorithm and the like.

In embodiments of the present disclosure, after the access key is set for the use trace file in the memory, in subsequent use, when it needs to perform a write operation on the use trace file, the write operation may be performed directly or the information corresponding to the write operation may be encrypted and written into the use trace file. When it needs to perform a read operation on the use trace file, the user needs to input the corresponding access key, and only when the access key input by the user is consistent with the access key set for the use trace file, the read operation can be performed on the use trace file. Thus, it is possible to effectively protect the lawbreakers from hacking into the client and reading the use trace file from the memory when the application is running (which leads to leakage of the privacy information of the user when the application is running), thereby improving the security of the privacy information.

At block 102, the read/write operation corresponding to the file read/write request is performed on redirected use trace file.

At this block, performing the read/write operation corresponding to the file read/write request on the redirected use trace file may include: if the file read/write request is a write request, writing information carried in the file read/write request into the redirected use trace file, and if the file read/write request is a read request, reading the information required to be read in the fire read/write request from the redirected use trace file.

In embodiments of the present disclosure, redirecting means switching to performing the read/write operation on the use trace file stored in the memory from performing the read/write operation on the use trace file stored in the hard disk or the flash memory in a process of starting the application.

At block 103, after monitoring that the application exits, the use trace file mapped by the application in the memory is erased according to a preset erasing strategy.

At this block, in a period from the time when the application is started to the time when the application exits, the use traces generated when the user uses the application are recorded in the use trace file mapped by the identifier of the application in the memory.

In actual use, since memory resource in the client is limited, the memory in the client is only used for temporary storage, and when the client is powered off or restarted, the information stored in the memory will be erased automatically. In embodiments of the present disclosure, preferably, in order to save the memory resource, the use traces are stored in the memory when the user is using the application. When the application exits, the use traces corresponding to the application temporarily stored in the memory are erased. Therefore, the privacy information may be protected more effectively.

As an alternative embodiment, if there is enough memory resource, in order to simplify the user's operation after the application is restarted, erasing the use trace file mapped by the application in the memory according to a preset erasing strategy may include: determining whether the use trace file mapped by the application in the memory has the privacy information, if yes, erasing the privacy information, and if no, not performing processing.

At this block, the privacy information included in the use trace file rather than the whole use trace file is erased. For example, in terms of account information, the whole account information is erased, and in terms of email address information, content before the character @ is erased. Of course, in actual use, the privacy information may also include: information of a webpage browsed by the user, information of a period when the user stays on a webpage and information of a browser used by the user and the like.

As another alternative embodiment, erasing the use trace file mapped by the application in the memory according to a preset erasing strategy may include: determining whether the use trace file mapped by the application in the memory has the privacy information, if yes, replacing the privacy information with preset shielding characters, and if no, not performing processing.

At this block, a field corresponding to the privacy information may be converted to shielding characters, for example, the shielding characters corresponding to the privacy information is represented by x. As an example, if username=abc, after the converting, username=xxx.

It should be noted that, in embodiments of the present disclosure, the memory may be a physical memory in the client, or may be a virtual memory, or may also be other memories having a temporary storage function.

FIG. 2 is a block diagram of an apparatus for storing privacy information based on an application according to an embodiment of the present disclosure. As illustrated in FIG. 2, the apparatus includes: a filtering driver module 201, a privacy-mode service module 202 and a privacy-mode user interface module 203.

The filtering driver module 201 is configured to send a query request to the privacy-mode user interface module 203 after monitoring that the application has been started. If a returned query response indicates that a privacy mode is set for the started application, after a file read/write request from the started application is received, the filtering driver module is further configured to redirect the file read/write request to a use trace file mapped by an identifier of the application and preset in a memory, and to send a starting notification to the privacy-mode service module 202. After monitoring that the application exits, the filtering driver module is further configured to send an exiting notification to the privacy-mode service module 202 and the privacy-mode user interface module 203 respectively.

In embodiments of the present disclosure, as an alternative embodiment, the filtering driver module 201 includes a monitoring unit, a query processing unit, an exiting notifying unit and a redirecting unit (not illustrated in the drawings).

The monitoring unit is configured to output trigger information to the query processing unit after monitoring that the application has been started, and to output trigger information to the exiting notifying unit after monitoring that the application exits.

The query processing unit is configured to send the query request to the privacy-mode user interface module 203 according to the trigger information output by the monitoring unit, and to notify the redirecting unit if the returned query response indicates that the started application is set with the privacy mode.

The exiting notifying unit is configured to send the exiting notification to the privacy-mode service module 202 and the privacy-mode user interface module 203 respectively according to the trigger information output by the monitoring unit.

The redirecting unit is configured to receive the file read/write request from the application according to the notification output by the query processing unit, to redirect the file read/write request to the use trace file mapped by the identifier of the application and preset in the memory, and to send the starting notification to the privacy-mode service module 202.

In embodiments of the present disclosure, as an alternative embodiment, the redirecting unit may include a receiving subunit, a query subunit, a use trace file creating subunit, a first redirecting subunit and a second redirecting subunit.

The receiving subunit is configured to receive the file read/write request from the application according to the notification output by the query processing unit, and to output the file read/write request to the query subunit.

The query subunit is configured to receive the file read/write request from the application, query whether the use trace file mapped by the identifier of the application exists in the memory, if yes, output the file read/write request to the first redirecting subunit, and if no, output the file read/write request to the use trace file creating subunit.

The use trace file creating subunit is configured to create a new use trace file according to the file read/write request, to establish a mapping relation between the new use trace file and the identifier of the application, and to output the file read/write request to the second redirecting subunit.

The first redirecting subunit is configured to direct the file read/write request to the use trace file.

The second redirecting subunit is configured to direct the file read/write request to the new use trace file created by the use trace file creating subunit.

As an alternative embodiment, the redirecting unit may further include a memory space allocating subunit configured to invoke a cache space allocation function, and to apply for a cache space in the memory for the new use trace file created by the use trace file creating subunit.

As another alternative embodiment, the redirecting unit may further include an encrypting subunit configured to set an access key for the use trace file created by the use trace file creating subunit using a preset encryption algorithm.

The privacy-mode service module 202 is configured to receive the starting notification, to perform a read/write operation corresponding to the file read/write request on the redirected use trace file, to receive the exiting notification, and to erase the use trace file mapped by the application in the memory according to a preset erasing strategy and to remove a process corresponding to the exited application.

In embodiments of the present disclosure, as an alternative embodiment, the privacy-mode service module 202 includes a receiving determining unit, a writing unit, a reading unit and an exiting processing unit (not illustrated in the drawings).

The receiving determining unit is configured to, after receiving the starting notification, output the file read/write request to the writing unit if the file read/write request is a write request, and output the file read/write request to the reading unit if the file write/read request is a read request; and after receiving the exiting notification, output the exiting notification to the exiting processing unit.

The writing unit is configured to receive the file read/write request, and to write information carried in the file read/write request into the redirected use trace file.

The reading unit is configured to receive the file read/write request, and to read information required to be read in the file read/write request from the redirected use trace file.

The exiting processing unit is configured to receive the exiting notification, to erase the use trace file mapped by the application in the memory according to the preset erasing strategy and to remove the process corresponding to the exited application.

In embodiments of the present disclosure, as an alternative embodiment, erasing the use trace file mapped by the application in the memory according to a preset erasing strategy may include: determining whether the use trace file mapped by the application in the memory has the privacy information, if yes, erasing the privacy information, and if no, not performing processing.

As another alternative embodiment, erasing the use trace file mapped by the application in the memory according to a preset erasing strategy may include: determining whether the use trace file mapped by the application in the memory has the privacy information, if yes, replacing the privacy information by preset shielding characters, and if no, not performing processing.

The privacy-mode user interface module 203 is configured to: set the privacy mode for the application; after the query request sent by the filtering driver module 201 is received, if the application is set with the privacy mode, start the privacy-mode service module 202, and return the query response indicating that the started application is set with the privacy mode to the filtering driver module 201; receive the exiting notification from the filtering driver module 201, and close the privacy-mode service module 202 after monitoring that the privacy-mode service module 202 has erased the use trace file.

In embodiments of the present disclosure, as an alternative embodiment, the privacy-mode user interface module 203 includes a privacy mode setting unit, a query request processing unit and an exiting notification processing unit (not illustrated in the drawings).

The privacy mode setting unit is configured to preset the privacy mode for the application.

The query request processing unit is configured to query the privacy mode setting unit after the query request sent by the filtering driver module 201 is received, to start the privacy-mode service module 202 and return the query response indicating that the started application is set with the privacy mode to the filtering driver module 201 if the application is set with the privacy mode.

The exiting notification processing unit is configured to receive the exiting notification from the filtering driving module 201, and to close the privacy-mode service module 202 after monitoring that the privacy-mode service module 202 has erased the use trace file.

As another alternative embodiment, the privacy-mode user interface module 203 may further include a privacy mode updating unit configured to acquire a process list corresponding to currently running applications, to check process states in the process list, to select a process to be set from processes of which processes states are in the non-privacy mode, to update the process state of the selected application as a privacy mode, to set the application corresponding to the selected process into the privacy mode setting unit, and to notify the query request processing unit.

As yet another alternative embodiment, the privacy-mode user interface module 203 may further include a prompt processing unit configured to promote the user whether to set the privacy mode for the application if the application is not set with the privacy mode, in which, if the user selects to set the privacy mode for the application according to the promote, after the privacy mode is set for the application automatically and the application is set in the privacy mode setting unit, the prompt processing unit is configured to notify the query request processing unit to start the privacy-mode service module 202, and if the user gives up to set the privacy mode for the application according to the promote, a current process is performed.

In embodiments of the present disclosure, the privacy-mode user interface module may preset the privacy mode for the application (i.e., select the application which needs to enter the privacy mode from the applications not in the privacy mode); after the application is started, the filtering driver module may query the privacy-mode user interface module whether the started application is set with the privacy mode, if yes, redirect the read/write operation of the use trace file, and trigger the privacy-mode user interface module to start the privacy-mode service module, such that the privacy-mode service module may perform the read/write operation corresponding to the file read/write request in the redirected use trace file. In detail, the filtering driver module is configured to capture the file read/write request of the application, and decide whether to redirect the file read/write request according to a current state of the application (whether the privacy mode is set for the application), and if yes, perform the redirecting and send a starting notification to the privacy-mode service module, such that the privacy-mode service module may perform the read/write operation corresponding to the file read/write request in the redirected use trace file. Thus, the information used by the application in the stage of starting and initializing may still be the use traces in a real file such as a registry, a local database and an initialization file stored in the hard disk or the flash memory until loading the application is completed and the privacy mode is started, and after loading the application is completed, the file disk read/write request for the application may be redirected to the memory, rather than performing the read/write operation in the hard disk or the flash memory.

When the application exits, the filtering driver module monitors that the application exits, and notifies the privacy-mode service module to erase the process corresponding to the exited application from the privacy-mode service module.

In embodiments of the present disclosure, in a period from the time when the application is loaded completely to the time when the application exits, all the use traces of the user recorded by the application are stored in the memory, and these recorded use traces are erased from the memory after the application exits, such that the privacy information will not be left after the user uses the application, thereby improving the security of the user's privacy information.

In order to achieve the above objectives, embodiments of the present disclosure provide a client. FIG. 3 is a structure diagram of a client according to an embodiment of the present disclosure. As illustrated in FIG. 3, the client includes a housing 61, a processor 62, a memory 63, a circuit board 64 and a power supply circuit 65. The circuit board 64 is arranged inside a space enclosed by the housing 61, the processor 62 and the memory 63 are disposed on the circuit board 64; the power supply circuit 65 is configured to supply power to respective circuits or components of the client; the memory 63 is configured to store executable program codes; and the processor 62 is configured to run a program corresponding to the executable program codes by reading the executable program codes stored in the memory 63, so as to perform the method for storing privacy information based on an application according to embodiments of the present disclosure illustrated in FIG. 1.

Embodiments of the present disclosure also provide a computer readable storage medium having instructions stored thereon that, when executed, performs the method for storing privacy information based on an application according to embodiments of the present disclosure illustrated in FIG. 1.

Embodiments of the present disclosure also provide a computer program, which when running on a processor of a client, performs the method for storing privacy information based on an application according to embodiments of the present disclosure illustrated in FIG. 1.

It can be seen from above that, with the method and the apparatus for storing privacy information based on an application according to embodiments of the present disclosure, by redirecting the user's disk read/write operation to the memory from the hard disk or the flash memory, the use traces (disk read/write operation) generated when the user uses the application may be only stored in the memory when the application is running, and when the application exists, the use traces are erased automatically by the memory, such that the disk-recorded use traces may be not generated after the user uses the application without affecting the user's using the application normally. Therefore, use traces generated when the user uses the application may be reduced greatly, the privacy information of the user may be protected effectively, and a disk read/write performance may be improved in some scenes.

The logic and/or step described in other manners herein or shown in the flow chart, for example, a particular sequence table of executable instructions for realizing the logical function, may be specifically achieved in any computer readable medium to be used by the instruction execution system, device or equipment (such as the system based on computers, the system comprising processors or other systems capable of obtaining the instruction from the instruction execution system, device and equipment and executing the instruction), or to be used in combination with the instruction execution system, device and equipment. As to the specification, “the computer readable medium” may be any device adaptive for including, storing, communicating, propagating or transferring programs to be used by or in combination with the instruction execution system, device or equipment. More specific examples of the computer readable medium comprise but are not limited to: an electronic connection (an electronic device) with one or more wires, a portable computer enclosure (a magnetic device), a random access memory (RAM), a read only memory (ROM), an erasable programmable read-only memory (EPROM or a flash memory), an optical fiber device and a portable compact disk read-only memory (CDROM). In addition, the computer readable medium may even be a paper or other appropriate medium capable of printing programs thereon, this is because, for example, the paper or other appropriate medium may be optically scanned and then edited, decrypted or processed with other appropriate methods when necessary to obtain the programs in an electric manner, and then the programs may be stored in the computer memories.

It should be understood that each part of the present disclosure may be realized by the hardware, software, firmware or their combination. In the above embodiments, a plurality of acts or methods may be realized by the software or firmware stored in the memory and executed by the appropriate instruction execution system. For example, if it is realized by the hardware, likewise in another embodiment, the acts or methods may be realized by one or a combination of the following techniques known in the art: a discrete logic circuit having a logic gate circuit for realizing a logic function of a data signal, an application-specific integrated circuit having an appropriate combination logic gate circuit, a programmable gate array (PGA), a field programmable gate array (FPGA), etc.

The embodiments described above are merely detail implementations of the present disclosure, but the scope of the present disclosure does not limited thereto. For the skilled in the art, the present disclosure may include alternatives, modifications and equivalents within the spirit and scope of the appended claims.

1. A method for storing privacy information based on an application, comprising:
after monitoring that the application has been started, receiving a file read/write request from the started application, and redirecting the file read/write request to a use trace file mapped by an identifier of the application and preset in a memory;
performing a read/write operation corresponding to the file read/write request on the use trace file; and
after monitoring that the application exits, erasing the use trace file mapped by the application in the memory according to a preset erasing strategy.

2. The method according to claim 1, wherein after monitoring that the application has been started and before receiving a file read/write request from the started application, the method further comprises:
acquiring a process list corresponding to currently running applications; and
checking process states in the process list, and updating the process state of the application from a non-privacy mode to a privacy mode.

3. The method according to claim 1, wherein after monitoring that the application has been started and before receiving a file read/write request from the started application, the method further comprises:
determining whether the application is set with a privacy mode, comprising:
if the application is set with the privacy mode, receiving the file read/write request from the started application; and
if the application is not set with the privacy mode, promoting a user whether to set a privacy mode for the application, and performing a corresponding operation according to the user's setting.

4. The method according to claim 3, wherein determining whether the application is set with the privacy mode comprises:
querying a preset privacy mode list, and determining whether the started application exists in the preset privacy mode list; or
determining whether the identifier of the application carries privacy mode information.

5. The method according to claim 3, wherein performing a corresponding operation according to the user's setting comprises:
if the user selects to set the privacy mode for the application according to the promote, setting the privacy mode for the application automatically, and receiving the file read/write request from the started application and redirecting the file read/write request to the use trace file mapped by the identifier of the application and preset in the memory; and
if the user gives up to set the privacy mode for the application according to the promote, receiving the file read/write request from the started application and directing the file read/write request to the use trace file stored in a hard disk or a flash memory.

6. The method according to claim 1, wherein redirecting the file read/write request to a use trace file mapped by an identifier of the application and preset in a memory comprises:
querying whether the use trace file mapped by the identifier of the application exists in the memory;
if yes, directing the file read/write request to the use trace file; and
if no, creating a new use trace file, establishing a mapping relation between the new use trace file and the identifier of the application, and directing the file read/write request to the new use trace file.

7. The method according to claim 6, further comprising:
invoking a cache space allocation function, and applying for a cache space in the memory for the new use trace file.

8. The method according to claim 6, further comprising:
setting an access key for the use trace file mapped by the identifier of the application or the new use trace file using a preset encryption algorithm.

9. The method according to claim 1, wherein performing a read/write operation corresponding to the file read/write request on the use trace file comprises:
if the file read/write request is a write request, writing information carried in the file read/write request into redirected use trace file; and
if the file read/write request is a read request, reading information required to be read in the fire read/write request from the redirected use trace file.

10. The method according to claim 1, wherein erasing the use trace file mapped by the application in the memory according to a preset erasing strategy comprises:
determining whether the use trace file mapped by the application in the memory has privacy information;
if yes, erasing the privacy information or replacing the privacy information with preset shielding characters; and
if no, remaining the use trace file mapped by the application in the memory.

11. (canceled)

12. An apparatus for storing privacy information based on an application, comprising a non-transitory computer-readable medium comprising computer-executable instructions stored thereon, and an instruction execution system which is configured by the instructions to implement at least one of a filtering driver module, a privacy-mode service module and a privacy-mode user interface module, wherein:
the filtering driver module is configured to:
send a query request to the privacy-mode user interface module after monitoring that the application has been started;
if a returned query response indicates that a privacy mode is set for the started application, after receiving a file read/write request from the started application, redirect the file read/write request to a use trace file mapped by an identifier of the application and preset in a memory and send a starting notification to the privacy-mode service module; and
after monitoring that the application exits, send an exiting notification to the privacy-mode service module and the privacy-mode user interface module respectively;
the privacy-mode service module is configured to receive the starting notification, to perform a read/write operation corresponding to the file read/write request on the use trace file, to receive the exiting notification, and to erase the use trace file mapped by the application in the memory according to a preset erasing strategy and to remove a process corresponding to the exited application; and
the privacy-mode user interface module is configured to:
set the privacy mode for the application;
after receiving the query request sent by the filtering driver module, if the application is set with the privacy mode, start the privacy-mode service module and return the query response indicating that the started application is set with the privacy mode to the filtering driver module; and
receive the exiting notification from the filtering driver module, and close the privacy-mode service module after monitoring that the privacy-mode service module has erased the use trace file.

13. The apparatus according to claim 12, wherein the filtering driver module comprises a monitoring unit, a query processing unit, an exiting notifying unit and a redirecting unit, in which,
the monitoring unit is configured to output trigger information to the query processing unit after monitoring that the application has been started, and to output trigger information to the exiting notifying unit after monitoring that the application exits;
the query processing unit is configured to send the query request to the privacy-mode user interface module according to the trigger information output by the monitoring unit, and to notify the redirecting unit if the returned query response indicates that the started application is set with the privacy mode;
the exiting notifying unit is configured to send the exiting notification to the privacy-mode service module and the privacy-mode user interface module respectively according to the trigger information output by the monitoring unit; and
the redirecting unit is configured to receive the file read/write request from the application according to the notification output by the query processing unit, to redirect the file read/write request to the use trace file mapped by the identifier of the application and preset in the memory, and to send the starting notification to the privacy-mode service module.

14. The apparatus according to claim 13, wherein the redirecting unit comprises a receiving subunit, a query subunit, a use trace file creating subunit, a first redirecting subunit and a second redirecting subunit, in which,
the receiving subunit is configured to receive the file read/write request from the application according to the notification output by the query processing unit, and to output the file read/write request to the query subunit;
the query subunit is configured to receive the file read/write request of the application, to query whether the use trace file mapped by the identifier of the application exits in the memory, if yes, to output the file read/write request to the first redirecting subunit, and if no, to output the file read/write request to the use trace file creating subunit;
the use trace file creating subunit is configured to create a new use trace file according to the file read/write request, to establish a mapping relation between the new use trace file and the identifier of the application, and to output the file read/write request to the second redirecting subunit;
the first redirecting subunit is configured to direct the file read/write request to the use trace file; and
the second redirecting subunit is configured to direct the file read/write request to the new use trace file created by the use trace file creating subunit.

15. The apparatus according to claim 14, wherein the redirecting unit further comprises at least one of:
a memory space allocating subunit, configured to invoke a cache space allocation function, and to apply for a cache space in the memory for the new use trace file created by the use trace file creating subunit; and
an encrypting subunit, configured to set an access key for the use trace file created by the use trace file creating subunit using a preset encryption algorithm.

16. (canceled)

17. The apparatus according to claim 12, wherein the privacy-mode service module comprises a receiving determining unit, a writing unit, a reading unit and an exiting processing unit, in which,
the receiving judging unit is configured to:
after receiving the starting notification, output the file read/write request to the writing unit if the file read/write request is a write request, and output the fire read/write request to the reading unit if the file read/write request is a read request; and
after receiving the exiting notification, output the exiting notification to the exiting processing unit;
the writing unit is configured to receive the file read/write request, and to write information carried in the file read/write request into the redirected use trace file;
the reading unit is configured to receive the file read/write request, and to read information required to be read in the file read/write request from the redirected use trace file; and
the exiting processing unit is configured to receive the exiting notification, to erase the use trace file mapped by the application in the memory according to the preset erasing strategy, and to remove the process corresponding to the exited application.

18. The apparatus according to claim 12, wherein the privacy-mode user interface module comprises a privacy mode setting unit, a query request processing unit and an exiting notification processing unit, in which,
the privacy mode setting unit is configured to preset the privacy mode for the application;
the query request processing unit is configured to:
query the privacy mode setting unit after receiving the query request sent by the filtering driver module; and
if the application is set with the privacy mode, start the privacy-mode service module, and return the query response indicating that the started application is set with the privacy mode to the filtering driver module; and
the exiting notification processing unit is configured to receive the exiting notification from the filtering driving module, and to close the privacy-mode service module after monitoring that the privacy-mode service module has erased the use trace file.

19. The apparatus according to claim 18, wherein the privacy-mode user interface module further comprises at least one of:
a privacy mode updating unit, configured to acquire a process list corresponding to currently running applications, to check process states in the process list, to select a process to be set from processes of which processes states are in the non-privacy mode, to update the process state of the selected application as a privacy mode, to set the application corresponding to the selected process into the privacy mode setting unit, and to notify the query request processing unit; and
a prompt processing unit, configured to promote the user whether to set the privacy mode for the application if the application is not set with the privacy mode; if the user selects to set the privacy mode for the application according to the promote, after the privacy mode is set for the application automatically and the application is set in the privacy mode setting unit, notify the query request processing unit to start the privacy-mode service module.

20. (canceled)

21. A client, comprising a housing, a processor, a memory, a circuit board and a power supply circuit, wherein the circuit board is arranged inside a space enclosed by the housing; the processor and the memory are disposed on the circuit board; the power supply circuit is configured to supply power to respective circuits or components of the client; the memory is configured to store executable program codes; and the processor is configured to run a program corresponding to the executable program codes by reading the executable program codes stored in the memory, so as to perform the method for storing privacy information based on an application, the method comprising:
after monitoring that the application has been started, receiving a file read/write request from the started application, and redirecting the file read/write request to a use trace file mapped by an identifier of the application and preset in a memory;
performing a read/write operation corresponding to the file read/write request on the use trace file; and
after monitoring that the application exits, erasing the use trace file mapped by the application in the memory according to a preset erasing strategy.

22.-23. (canceled)
